(19) United States
(12) Patent Application Publication
(10) Pub. No.: US 2016/0085866 A1
(43) Pub. Date: Mar. 24, 2016

(54) SYSTEM FOR PERFORMING TEXT MINING AND TOPIC DISCOVERY FOR ANTICIPATORY IDENTIFICATION OF EMERGING TRENDS

(71) Applicant: MINETTA BROOK INC., Kirkland, WA (US)

(72) Inventors: Prabhu Venkatesh, Kirkland, WA (US); Viplav Nigam, Kirkland, WA (US); Deepak Bharadwaj, Kirkland, WA (US); Chandra Jonelagadda, Kirkland, WA (US)

(73) Assignee: MINETTA BROOK INC., Krikland, WA (US)

(21) Appl. No.: 14/862,507

(22) Filed: Sep. 23, 2015

Related U.S. Application Data
(60) Provisional application No. 62/054,317, filed on Sep. 23, 2014.

(51) Int. Cl. G06F 17/30

(52) U.S. Cl. CPC G06F 17/30867; G06F 17/30528; G06F 17/30554

(57) ABSTRACT

This disclosure describes a system that facilitates analyzing a broad and continuously updated sample of recent written communications for the purpose of identifying emerging and important news and topic developments before they attract broad attention. The system continuously discovers topics and relationships between topics in the written communications as the communications are received. Individual topics and topic relationships are continuously analyzed for the purpose of detecting changes in the frequency and manner in which the topics are addressed and changes in the content that accompanies the topics. The system uses this analysis as the basis for identifying certain topics and the communications that address them as emerging, and therefore, important. The system uses a display feature to highlight these topics and communications for a user to review or investigate further.

### CROSS REFERENCE TO RELATED APPLICATIONS

This application claims the benefit of and priority to U.S. Provisional Application 62/054,317, filed on Sep. 23, 2014, which is hereby incorporated by reference in its entirety.

### TECHNICAL FIELD

The present application relates to text mining of documents, messages and news articles for the purpose of identifying topics that will become increasingly prevalent or important.

### BACKGROUND

In many contexts, there are opportunities to derive tremendous benefits from the identification of important communications prior to the communications gaining substantial attention. For example, in the financial world, traders having the ability to recognize critical news issues and topics would have an informational advantage in the marketplace. In certain international security, counter-terrorism, and law enforcement contexts, the ability to identify key communications obtained in a large surveillance operation could help identify risks or targets, and guide intervening action.

### BRIEF SUMMARY

This disclosure describes methods, system and computer-program products for performing operations that facilitate identifying news stories and topics that will grow in prevalence. The operations include identifying a first topic and a second topic within a news article, wherein both the first topic and the second topic are represented by words in the news article, and wherein the words in the news article are associated with grammatical structures, quantifying a strength of a relationship between the first topic and second topic within the news article, wherein the strength of the relationship is quantified based on the grammatical structures, accessing data regarding strength of relationships between the first topic and the second topic in other news articles and a frequency of co-occurrence of the first topic and the second topic within the other news articles, calculating a relevance score with respect to the news article, wherein the relevance score is calculated at a computing-device and based on the strength of the relationship between the first topic and the second topic, and the data regarding strength of relationships between the first topic and the second topic within the other news articles, selecting the news article for display, wherein the news article is selected from amongst multiple other news articles evaluated for display, and wherein the news article is selected based on the relevance score.

### BRIEF DESCRIPTION OF THE DRAWINGS

Aspects of the disclosure are illustrated by way of example. In the accompanying figures, like reference numbers indicate similar elements, and:

FIG. 1 is a block diagram with an example of a computerized system configured to perform operations and use techniques described in this disclosure.

FIG. 2 is a block diagram illustrating an example use of memory to store news articles, statistics, topic and company relationships, and metadata.

FIG. 3 is a time horizon diagram that depicts an analysis period and comparison period.

FIG. 4 is a flow diagram illustrating example operations that may be performed by the system described in this disclosure.

FIG. 5 depicts an example of an additional or alternative series of operations that a computing device may use to assemble a time series hierarchy prescribed by a hierarchical schema.

FIG. 6 depicts an example of an additional or alternative series of operations that a computing device may use to assemble a time series hierarchy prescribed by a hierarchical schema.

FIGS. 7-10 are examples of certain functionality and information that can be provided at a user interface and display screen of the type described in this disclosure.

### DETAILED DESCRIPTION

This application describes a computerized analysis and display system (hereinafter referred to as “the system” or “system”) for analyzing a broad and continuously updated sample of recent written communications for the purpose of identifying emerging and important social developments before they attract broad attention. The system works by continuously discovering topics and relationships between topics in the written communications as the communications are received. Individual topics and topic relationships are continuously analyzed for the purpose of detecting changes in the frequency and manner in which the topics are addressed and changes in the content that accompanies the topics. The system uses this analysis as the basis for identifying certain topics and the communications that address them as emerging, and therefore, important. The system uses a display feature to highlight these topics and communications for a user to review or investigate further.

The system may be advantageously used in several financial trading environments because business and financial news provides a vast sample of written communications regarding a wide variety of topics, any number of which have the potential to grow in importance, scope and exposure over time. The fact that the system quickly provides advanced notice regarding topics that subsequently grow in terms of exposure and significance means that traders can use the system to obtain an informational advantage.

Because it is easy to understand how the system can be advantageously applied in the context of financial trading, the operations and methods that the system uses will be explained with regard to an example financial context. In this context, the system is used as a source of information by equities traders, and will be described as such. Upon reading this explanation of system operations in a financial context, people of ordinary skill in the arts to which this disclosure is relevant will be able to easily recognize and understand any modifications of system operations, analytics and functionality needed to use the system in other contexts beyond equities trading. Several such applications of the system will be briefly discussed later in this disclosure.

Also, every system application or utilization context mentioned in this disclosure is provided as an example to suggest some of the numerous and varied usage environments in which the system may be operated, as well as the many problems that the system may be used to address. Thus, this disclosure should not be interpreted as having a scope or relevance limited to any particular usage environment or applications of the system.

When the system is configured to be used as an information tool for equities traders, it analyzes business news articles and written messages (for purposes of simplicity, the term “news article” shall be understand to refer to any written communication represented in an electronic format suitable for computerized processing) in real-time for the purpose of discovering topics and topic relationships in the articles and messages. The system calculates information about the prevalence of the discovered topics and topic relationships, as well as the strength of the topic relationships. The system then uses the calculated information to identify topics that will become more significant in the media, within social networks, or within any other informational outlets.

Within any analyzed news article, any number of specifically-named companies may be topics that the article addresses. In order to better sort and analyze these articles for use by equities traders, the system includes a capability for determining that a discovered topic is a company and for identifying the company itself. Hereinafter, a company that is a topic of a news article will be referred to as being “referenced by the news article”. The system discovers companies referenced by news articles in much the same way as it discovers other topics, and treats referenced companies much like discovered topics for the purpose of determining news article relevance. However, referenced companies are stored separately so that the system may provide certain display, sorting and analytic features that enable a user to review news articles based on a criteria defined with respect to company references.

The system identifies any two topics as being related when they co-occur in a same news article. A pair of topics or companies co-occur within a same news article when the system determines, based on analysis of the article's text, that the article explicitly references or addresses both topics or companies of the pair. The system uses a similar criteria to detect co-occurrences of a topic and company within a same news article.

When co-occurring topics are found in any article, the system evaluates the grammatical structure of the article to determine a strength of the topic relationship in the article. A variety of criteria may be used to perform these evaluations. For example, the system may consider the number of sentences in the news article that refer to both topics, and whether pronouns are used to refer to the topics.

By evaluating both topic prevalence (i.e. number of times a topic appears in news articles) and the strength of relationships between topics across a large sample of news articles, the system is able to better evaluate the importance of topics. For example, it is not uncommon for two topics to appear in news articles with similar regularity during a short period of time, even though historically, one of the topics may tend to appear in conjunction with historically prevalent topics far more frequently than the other topic. In such a case, the topic that appears more often with historically prevalent topics would ordinarily be more likely than the other topic to grow in importance. By analyzing topic relationships in news articles, the system is able to compare and analyze topics in a way that captures differences in the importance of topics that may not be manifested solely in prevalence data.

As mentioned previously, the system discovers references to particular companies and co-occurring references to companies and topics within the news articles. These capabilities enable the system to determine the relevance of information about specific companies in the news, estimate the extent to which recently-released news will affect particular companies, identify companies expected to be more widely-covered by news stories in the future, and link companies to topics and news articles that may be most relevant to those companies in the future.

The system uses advanced text parsing techniques to identify topics and companies referenced in the news. The techniques enable the system to identify multiple references to a same topic or company and determine that the same subject is being referenced in each case, even when different words and names are used.

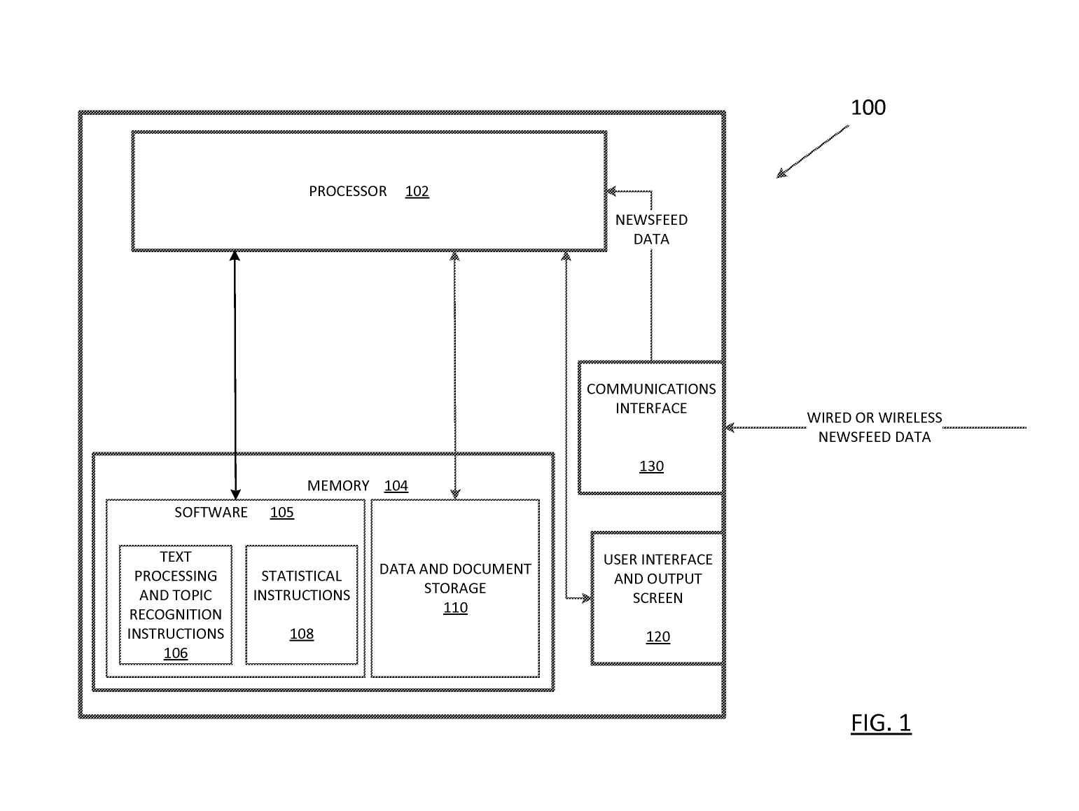

FIG. 1 illustrates one simplified example of the components of a system 100 having capabilities and features for implementing the processes and technical improvements described herein. The system 100 includes a processor 102, memory 104 and communications interface 130. The processor 102 executes processing instructions provided by software 105, which is stored in memory 104. The instructions provided by the software 105 include instructions for text processing and topic recognition, discovery of topics and companies and references to companies, document and message storage, indexing and retrieval, statistical analysis of topic and company prevalence data, and any additional operations that may be necessary or beneficial for employing the techniques and methods or implementing the technical improvements described herein. FIG. 1 depicts text processing and topic recognition instructions 106 and statistical instructions 108, although, as mentioned above, the system may execute instructions beyond those that are depicted.

The system 100 also includes a user interface and output screen 120. On the user interface and output screen 120, the system 100 displays interactive lists and charts that provide summaries or headlines from recent news articles, topic information, and statistics relevant to any individual news article or combination of articles. At the user interface and output screen 120, the text analysis system 100 provides functionality that enables a user to control the display of news articles and analytical information associated with the articles, sort news articles based on the topics and/or references to companies found in the articles, or filter news articles based on an analytical or content criteria.

Although not depicted in FIG. 1, the software 105 also includes instructions for receiving a real-time newsfeed over a wireless or wired communications channel. The well-known business newsfeed provided by Bloomberg is one example of a newsfeed that the system 100 is configured to receive and use as the informational source for the analysis that it performs. The system 100 uses the communications portal to access the communications channel, and receives a stream of news articles, social network communications and other documents that are transmitted to the system as part of the newsfeed shortly after these communications are published or posted. When the system 100 receives news articles or other communications, the processor 102 stores them in a memory 104 queue reserved for unevaluated news. The received articles or communications are stored in the queue in the order in which they are received.

The processor 102 then accesses and analyzes queued news articles individually to discover distinct topics and references to companies, as well as portions of the articles that are most relevant to the discovered topics and referenced companies. The processor 102 computes a score with respect to each news article, as well as a score with respect to each discovered topic and company referenced in the article. The scores represent estimates of the news relevance of their respective news article, topic or company.

In the context of articles or other communications, relevance refers to the extent to which the news article addresses topics and companies that are relevant. In the context of companies and topics, relevance refers to the extent to which the topic or company will receive significantly greater attention and coverage in the future than at a given present time. Thus, it is possible for a topic to be very important and be very closely followed by many people, yet not be evaluated as relevant by the system 100. This is especially true if interest and coverage of the topic has been building for a long time and is at a peak or plateau. It is also possible for a topic or company that is not being heavily covered in the news to be highly-relevant. This is especially true when the coverage of the topic is still fairly minimal, but has recently started to increase.

At any moment, the system 100 determines a topic's relevance based in part on a comparison of the frequency of discovery of the topic during a recent trailing time window and the frequency of discovery of the topic during an earlier time window. In this regard, the recent trailing time window will be referred to herein as the “analysis period”, and the earlier time window will be referred to as the “comparison period”. The relevance of a topic is increased by being discovered more regularly within articles received during the analysis period than within articles received during the comparison period. In this regard, the relevance varies as a function the percentage change in frequency of discovery of the topic.

A topic's relevance is also affected by the difference between the number of other topics and companies with which it was related during the analysis period and the number of other topics and companies with which it was related during the comparison period. All other factors being equal, the system 100 increases a topic's relevance in response to both increasing numbers of relationships with other topics and increasing numbers of relationships with other companies.

Additionally, in evaluating the relevance of a topic, the system 100 evaluates the strength of the relationships between the topic and other topics and companies. A topic's relevance is positively affected by increases in the strength of its relationships with other topics, and negatively affected by decreases in the strength of these relationships. A topic's relevance is also positively affected by increases in the relevance of other topics and companies to which it is related.

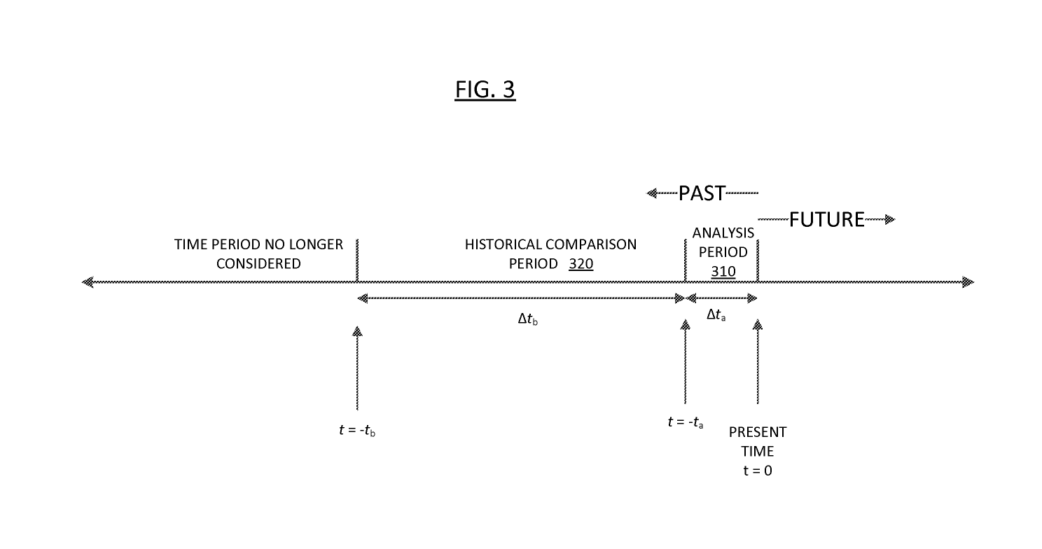

FIG. 3 is a generalized time horizon diagram that graphically explains the concept of the analysis period and comparison period that the system 100 uses to determine the magnitude of recent trends with regards to a topic's prevalence, the number and strength of its relationships with other topics, and the relevance of its related topics. As shown in FIG. 3, at any given instant of time (t=0), the analysis period 310 is a trailing time window extending backwards from the present. Taking Δtₐ to be the analysis period 310 duration, the analysis period 310 therefore looks back from the present (t=0) to time t=−Δtₐ. The time spanned (Δtₐ) by the analysis period 310 may be any amount of time, and the system 100 may delineate the analysis period 310 using a hard-encoded time duration parameter, or a modifiable user-inputted parameter stored in memory 104.

Periodic modification of the length of time spanned by the analysis period (Δtₐ) may enable the system 100 to be operated in a manner tailored to the amount of news information being placed in circulation at a given time. In operating the system described in this disclosure, the named inventors experimented with analysis periods 310 of various lengths and found that an analysis period 310 spanning one minute facilitates good system performance when used in conjunction with a comparison period that spans approximately one week.

Additionally, it is important to note that even though FIG. 3 appear to provide a snapshot in time, the analysis period is not static. That is, because the analysis period 310 is a trailing time window ending at the present moment of time, the specific time range falling within the analysis period 310 will change from one moment to the next.

The comparison period 320 is also an uninterrupted, trailing time window. However, unlike the analysis period, the time range of the comparison period 320 does not end at the present moment (t=0). Rather, the comparison period 320 encompasses an earlier range of time (t=−t_{b} . . . −tₐ) than the analysis period. The comparison period 320 may immediately precede the analysis period 310, as depicted in FIG. 3. Alternatively, the comparison period 320 may be offset from the analysis period 310.

In certain cases, the system 100 may continuously and rapidly receive and analyze news articles so that at any point in time, the system's data regarding topics and companies discovered in the news articles can be used as a representative sample of the universe of topics being addressed in a current media environment. The system 100 stores each document in memory 104 for a period of time, after which time the document may be deleted so as to free memory 104 for more recent news articles. The amount of time during which each news article is stored in memory 104 may be set as a user-inputted parameter, or the system 100 may simply delete news articles using a first-in-first-out methodology when available memory for new documents becomes limited. The system 100 uses and updates metadata that indexes discovered topics and companies to the stored articles in which they were discovered.

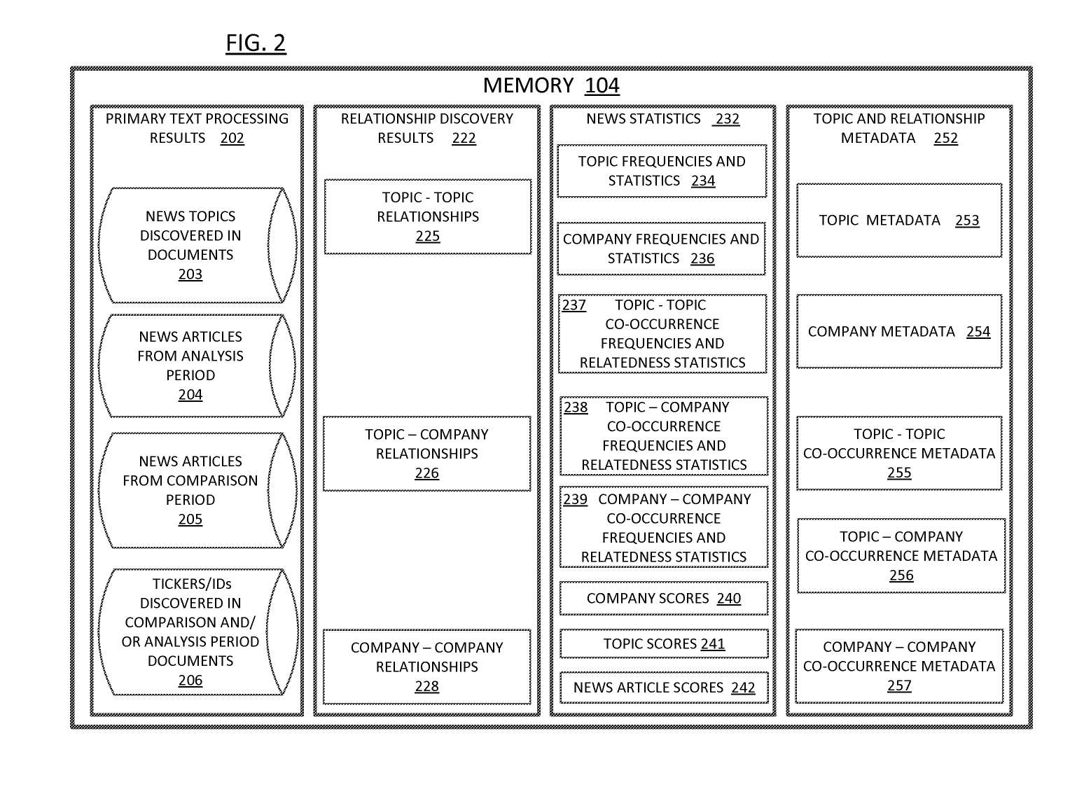

FIG. 2 is a generalized depiction of the use of memory 104 to store news articles and information derived from analysis of the news articles by the text analysis system 100. As shown in FIG. 2, the text analysis system 100 stores several types of data and information that they system 100 uses to analyze news articles, and to discover and track topics, references to companies and relationships involving topics and companies.

For example, FIG. 2 depicts the storage of what will be referred to as primary text processing results 202. The primary text processing results may include, amongst other things, the news articles received from the newsfeed during the analysis period, and the news articles received from the newsfeed during the comparison period. The primary text processing results 202 also include a list of topics discovered in the news articles of the comparison period 320 and analysis period 310. The processor 102 periodically sorts the list of news topics 203 discovered in the analysis period 310 and comparison period 320 so that the topics are maintained in order or their relevance.

The primary text processing results 202 also include a list of trading symbols (“tickers”) or other identifiers 206 that represent the companies that the system has discovered in the news articles of the analysis period 204 or news articles of the comparison period 205. For processing efficiency, it may be preferable that the system 100 be configured to periodically sort the list of trading symbols 206 so that the symbols are ordered according to the news relevance of the companies that they represent.

The processor 102 also uses the memory 104 to store relationship discovery results 222. The relationship discovery results 222 document relationships discovered in the news articles of the analysis period and the news articles of the comparison period. These relationships can include topic relationships that involve two or more topics that the system discovers together in at least one news article. The storage of these relationships is depicted at 225. The relationships can also include company relationships that involve two or more companies that the system discovers together in at least one news article. The storage of these relationships is depicted at 228. Additionally, the relationships can include hybrid relationships that involve one or more companies and one or more topics discovered together in at least one news article. The storage of hybrid relationships is depicted at 228.

The system also stores news statistics 232 that it uses to determine the relevance of news stories, topics and companies. The news statistics 232 include topic frequencies and statistics 234. The topic frequencies and statistics 234 are metrics that are computed with regard to individual topics stored at 203. Each frequency and statistic is indexed to the particular topic with respect to which it was computed. The topic frequencies and statistics 234 include separate frequency information and statistics with regard to the analysis period and the comparison period for each topic stored at 203. A topic frequency is the average number of news articles in which a topic appears within a predefined unit of time. Topic frequency statistics may be used to represent the manner in which a topic is distributed amongst documents, or other statistical characteristics of individual topics.

Topic frequency statistics may weight appearances of topics differently depending on the time of appearance. For example, the system may determine different frequency statistics with respect to a topic that appeared a certain number of times four days ago and a topic that appeared the same number of times six days ago, all other things being equal.

Company frequencies and statistics 236 are also stored in a manner that parallels the storage of the topic frequencies and statistics 234. The system may measure and use company frequencies and statistics 236 to represent the frequency and distribution of company information across a sample of documents, both during the analysis period 310 and comparison period 320.

As shown at 237, 238 and 239, the system 100 stores co-occurrence frequencies and relatedness statistics data for topic-topic co-occurrences, topic-company co-occurrences, and company-company co-occurrences, respectively. The relatedness statistics with regard to a co-occurrence reflect the strength of the relationship between the co-occurring topics or companies involved in the co-occurrence. With regard to each co-occurrence, the relationship strength is analyzed separately in both the analysis period and the comparison period.

The news statistics 232 also include a list of company scores 240. The system scores each of the company's represented on the list of tickers/IDs 206, and these scores are stored at 240. Each score computed for a company represents the current relevance of the company in the news. Moreover, the system 100 includes functionality for displaying these company scores on the user interface and output screen 120. For example, the system 100 provides users with a capability of reviewing the relevance scores of companies alongside news articles in which the companies are referenced. Additionally, the system 100 also provides the users with the ability to see a list of companies that are most relevant in the news without regard to the news articles that reference these companies.

The system 100 stores topic scores as depicted at 241, and news article scores as depicted at 242. News article scores 241 and company scores 242 represent the current relevance, as computed by the system 100, of the topics 203 and the companies represented by the tickers/IDs 206. For any given news articles stored at 204 or 204, the scores of companies and topics found in the article are the basis of the news article score stored at 242.

The system 100 also uses memory 106 to store topic and relationship metadata 252. The system 100 uses topic and relationship metadata as an index that stores the documents in which each topic and co-occurrence is found in. The topic and relationship metadata 252 includes topic metadata 252 that indexes each topic stored at 203 to the documents in which the topic was discovered. Company metadata 254 similarly indexes companies to documents. Topic-topic co-occurrence metadata 255, topic-company co-occurrence metadata 256, and company-company co-occurrence metadata 257 index co-occurrences to the documents in which they are found. Thus, for example, if a particular company (A) and topic (B) are discovered together in ten different documents, the topic-company co-occurrence metadata will include an entry B co-occur.

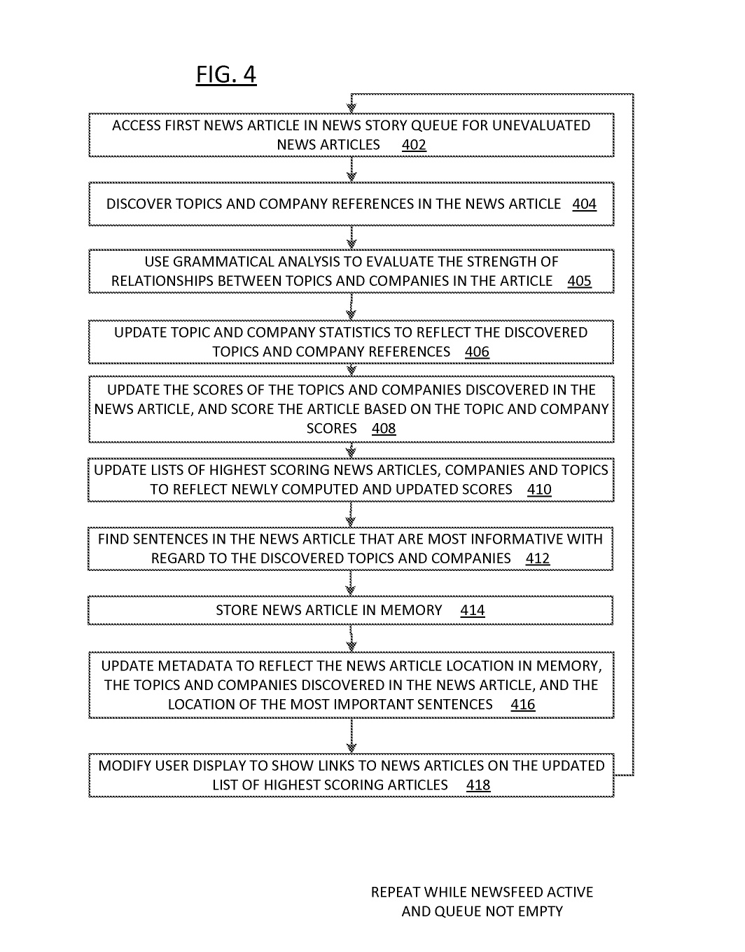

FIG. 4 is a flow diagram that summarizes example operations that may be performed by the system 100 to identify news articles, topics and companies that are most relevant. At 402, the system 100 accesses a first news article in a news story queue for unevaluated news stories 402. The system 100 may use the news articles queue to hold news stories recently received from the news feed, or any news articles pending analysis for the purpose of discovering the topics and companies that the article addresses.

At 404, the system discovers topics and company references in the news article. The system 100 makes these discoveries by parsing the text of the article. At 405, the system 100 uses grammatical analysis to evaluate the strength of relationships between the topics and the companies discovered in the news article. At 406, the system 100 updates topic and company statistics to reflect the discovered topics and referenced companies. This process includes updating metadata, frequency and relatedness statistics, and topic and company scores. The relatedness statistics are updated based on the strength of the relationships evaluated at 405.

At 408, the system updates the scores of the topics and companies discovered in the news article at 404. The scores are updated to reflect the new discovery of the topics and companies and their co-occurrence, as well as the new information provided by the news article with regard to the strength of the relationships between the topics and companies in the article.

At 410, the system 100 updates a list of highest scoring news articles, companies and topics to reflect the new scores resulting from the updating and scoring done at 408. At 412, the system performs additional text analysis to find sentences in the news article that are most informative with regard to the discovered topics and companies. The system 100 stores these most informative sentences in the topic metadata 253 or company metadata 254. In this way, the most informative sentences can be displayed as a news article excerpt during certain operations of the user interface and output screen 120. For example, when a user wishes to briefly review aspects of multiple news article without accessing the articles themselves, the system can display the most-informative sentences from the articles.

At 414, the system 100 stores the news article in memory so that it may be retrieved later, should a user wish to view it using the user interface and output screen 120. At 416, the system updates the topic and relationship metadata 252 so that the topics, companies, and co-occurrences discovered in the news article are indexed to the news article and its storage location in memory. At 418, the system 100 modifies the user display to show links to news articles on the updated list of highest-scoring articles.

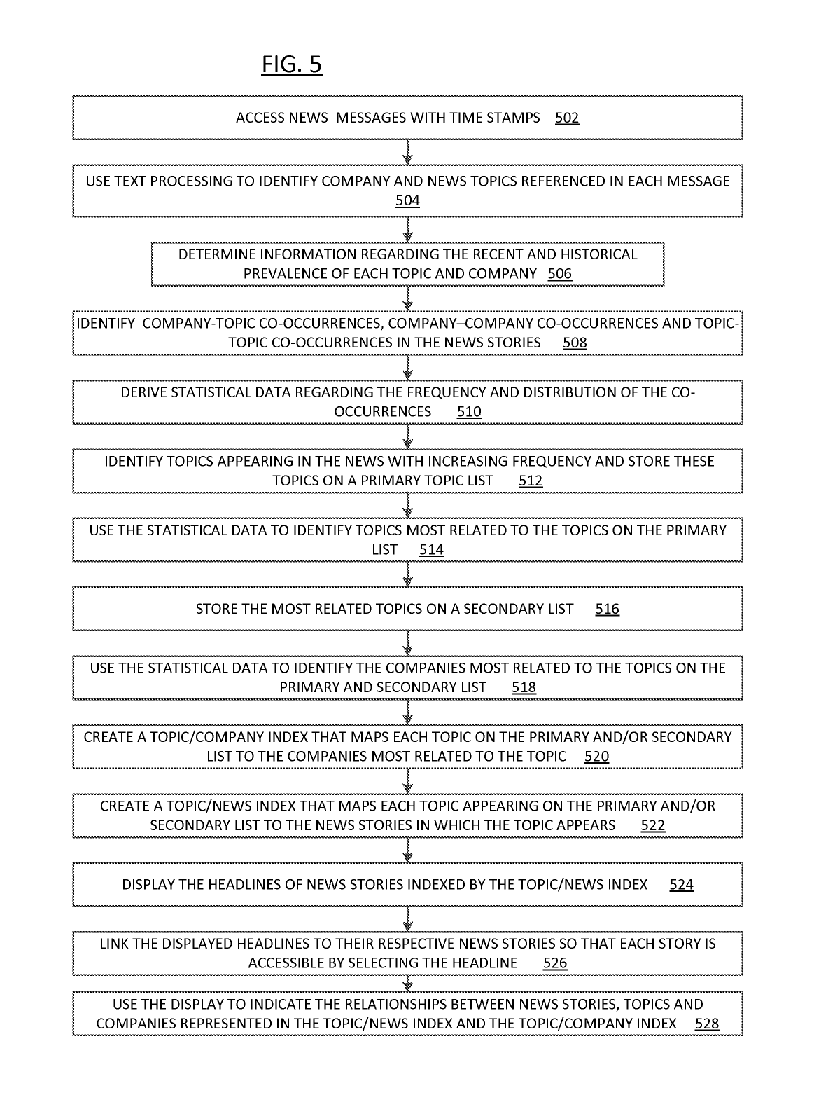

FIG. 5 is a flow diagram that provides a generalized depiction of an additional or alternative series of operations that the system 100 may use to identify relevant news articles and other messages. As depicted at 502, the system 100 accesses news articles that have time stamps. At 504, the system uses text processing to identify company and news topics referenced in each article.

At 506, the system 100 determines information regarding the recent and historical prevalence of each topic and company. At 508, the system 100 identifies company-topic co-occurrences, company-company co-occurrences, and topic-topic co-occurrences in the news stories. At 510, the system 100 derives statistical data regarding the frequency and distribution of the co-occurrences. At 512, the system identifies topics appearing in the news with increasing frequency and stores these topics as part of a primary topic list.

At 514, the system 100 uses the statistical data to identify topics most related to the topics on the primary list. At 516, the system stores the most related topics on a secondary list.

At 518, the system 100 uses the statistical data to identify the companies most related to the topics on the primary and secondary list. At 520, the system creates a topic/company index that maps each topic on the primary and/or secondary list to the companies most related to the topic.

At 522, the system 100 creates a topic/news index that maps each topic appearing on the primary and/or secondary list to the news stories in which the topic appears. At 524, the system displays the headlines of news stories indexed by the topic/news index. At 526, the system 100 links the displayed headlines to their respective news stories so that each story is accessible by selecting the headline on the user interface and output screen 120. At 528, the system uses the display to indicate the relationships between news stories, topics and companies represented in the topic/news index and the topic/company index.

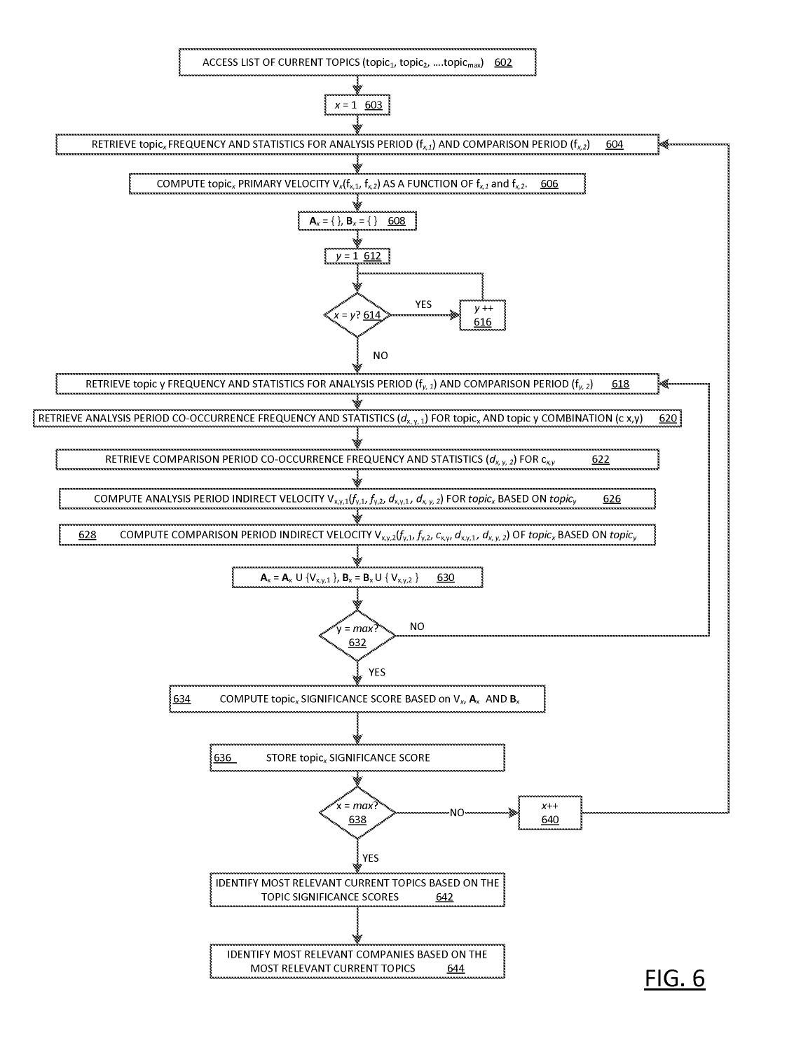

FIG. 6 is a flow diagram that provides a generalized depiction of an additional or alternative series of operations that the system 100 may use to identify relevant news articles and other messages once the system has discovered topics and companies in the articles. As depicted at 602 in FIG. 6, the system 100 accesses a list of current topics {topic₁, topic₂, . . . topicₘₐₓ}. At 603, the system sets a counting variable (x) equal to 1. At 604, the system 100 retrieves topicₓ frequency and statistics for a current analysis period and comparison period. The topicₓ statistics represent the prevalence of the topic during the analysis and comparison period, and weight more recent topic activity more heavily than older topic activity. At 606, the system computes topicx primary velocity Vₓ(f_{x,1}, f_{x,2}) as a function of f_{x,1} and f_{x,2}.

At 608, the system 100 initializes two empty sets (Aₓ and Bₓ). At 612, the system 100 initializes a second counting variable (y) to 1. If x=y at 614, then the system 100 increments y, as depicted at 616 If the system 100 determines that x and y are not equal at 614, then the system 100 retrieves topic_{y} frequency and statistics for the analysis period (f_{y,1}) and comparison period (f_{y,2}), as shown at 618. At 620, the system 100 retrieves analysis period co-occurrence frequency and statistics (d_{x,y,1}) for the combination of topicₓ and topic_{y}.

At 622, the system 100 retrieves comparison period co-occurrence frequency and statistics for c_{x,y}. At 626, the system 100 computes an analysis period indirect velocity V_{x,y,1}(ƒ_{y,1}, ƒ_{y,2}, d_{x,y,1}, d_{x,y,2}) for topicₓ based on topic_{y}. At 630, the system 100 adds the most-recently computed analysis period indirect velocity to set Aₓ. The system 100 also adds the most-recently computed comparison period indirect velocity to set Bₓ.

At 632, the system 100 determines if y is equal to max. If the answer is “no”, then the operations continue again at 618. Conversely, if the answer is “yes”, then the system 100 computes a significance score for topicₓ based on Vₓ, Aₓ AND Bₓ. At 636, the system 100 stores the significance score for topicₓ.

At 638, the system 100 determines if y is equal to max. If y and max are unequal, then the process continues at 604. Otherwise, the system 100 identifies the most relevant current topics based on the topic significance scores, as shown at 642. At 644, the system 100 identifies the most relevant companies based on the most relevant current topics.

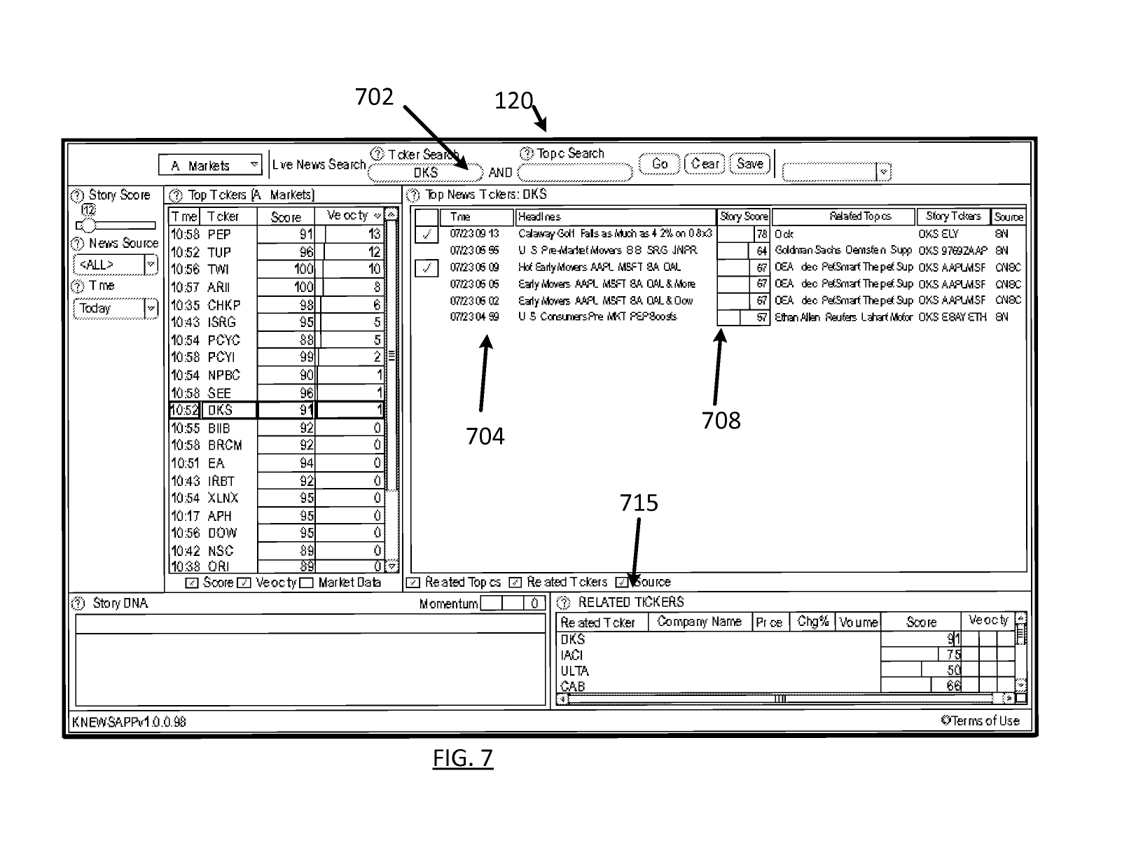

FIG. 7 is a screenshot illustrating example interactive features that may be displayed at the user interface and output screen 120. A shown in FIG. 7, the user interface and output screen 120 may be used to display a list of articles in which a specific company that has been specified by a user is referenced. That is, the user interface and output screen 120 enables a user to view those documents analyzed by the system 100 that reference a company that the user specifies. For example, in FIG. 7, the user has inputted the ticker “DKS” (Dick's Sporting Goods) in the ticker search box shown at 702. In response to this query, the system 100 has displayed six news headlines shown in a list of news stories at 704. Each of the documents references Dicks Sporting Goods. Although not seen in FIG. 7, the user interface and output screen 120 may include functionality that enables a user to click on any individual news story headline on the list 704. In response, the user interface and output screen 120 displays the entire text of the news story.

Additionally, the system 100 has scored each document and has outputted the scores next to the documents, as shown at 708. The scores indicate the relevance of the documents, with higher scores given to documents deemed to be of higher relevance.

Next to each of the documents that references Dick's Sporting Goods, the user interface and output screen 120 displays the topics that the system 100 has discovered in the documents. Further to the right, under a tab titled “Story Tickers”, the user interface and output screen 120 displays the tickers of the companies that the system 100 has discovered in the articles.

Towards the bottom of the user interface and output screen 120, the screen displays information under the heading “Related Tickers”, at 715. The “related tickers” section is a list of those companies that show the strongest analysis period relationships with Dick's Sporting Goods. This determination is based on the company relationship scores discussed earlier. Additionally, the “Related Tickers” section displays the score of each company represented by one of the displayed tickers. Each of these scores, as described earlier, represent the current relevance of the company to which it corresponds.

Towards the left side of the interface, the screen displays information under the heading “Top Tickers”, at 715. The “top tickers” section is a list of those companies having the highest overall relevance scores at the time of the display.

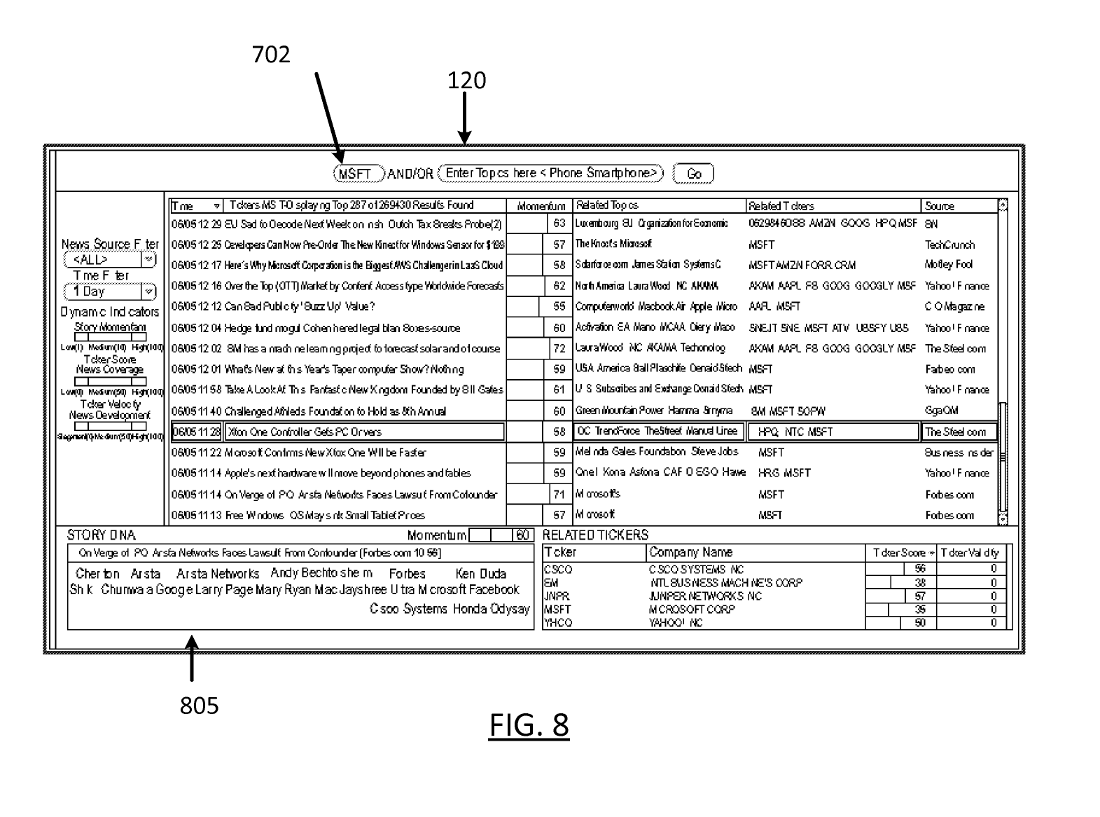

FIG. 8 is an additional illustration of the user interface and output screen 120 in a different mode of operations than was previously shown in FIG. 7. As shown in FIG. 8, the user interface and output screen 120 includes a “Story DNA” section, as shown at 805. The story DNA displays topics found within a selected story shown in the list of news story headlines 704.

The story DNA section 805 displays the topics as words, and the text of the each word is sized in proportion to the current relevance score of the topic that it represents.

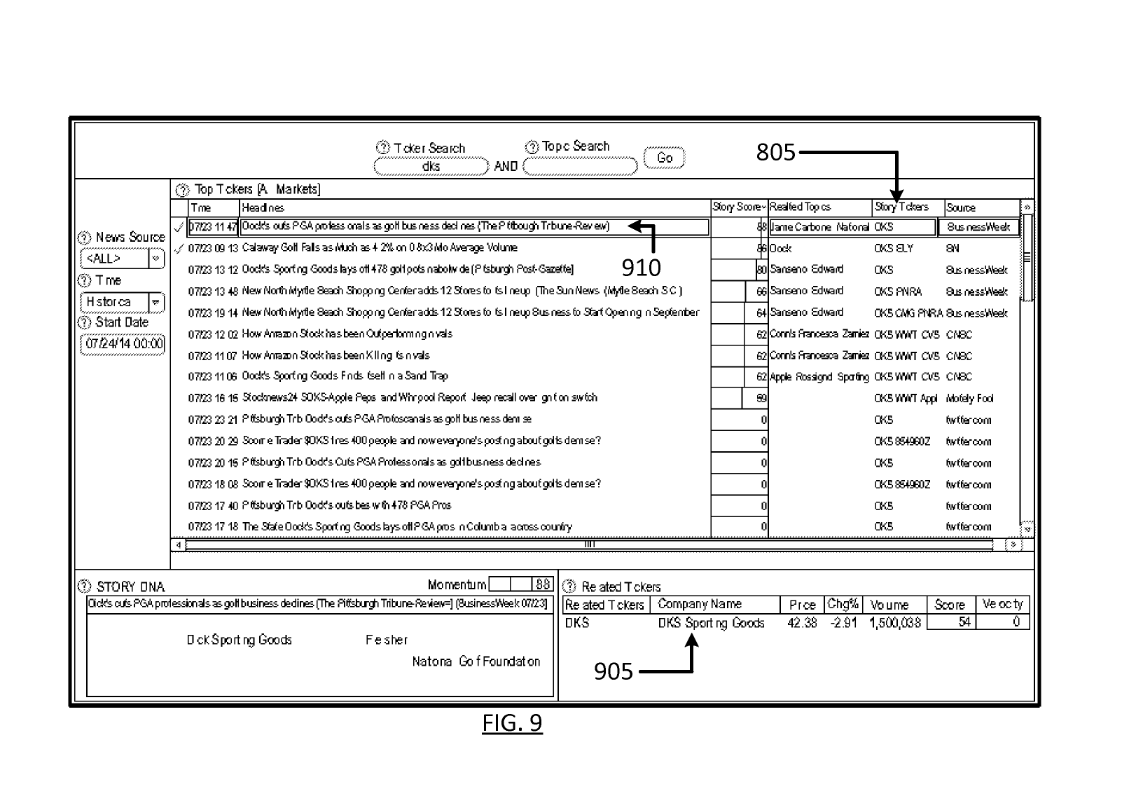

FIG. 9 is a screenshot of the user interface and output screen 120 during use of an additional display feature not explicitly described in the previous discussion of FIGS. 7 and 8. As shown in FIG. 9, stock market trading information 905 for Dick's Sporting Goods (DKS) is displayed in the section entitled “Related Tickers” 715. The stock market trading information 905 displayed on the user interface and display screen 120 includes stock price, a daily price change percentage, and the daily volume of shares traded.

The user interface and display screen 120 displays the stock market information for DKS because Dick's Sporting Goods is the one company that the system 100 has discovered within the article 910 highlighted by the cursor. The fact that the system 100 has discovered that the highlighted article 910 refers to DKS is indicated by the ticker symbol “DKS” being displayed under the heading “Story Tickers”, at 920.

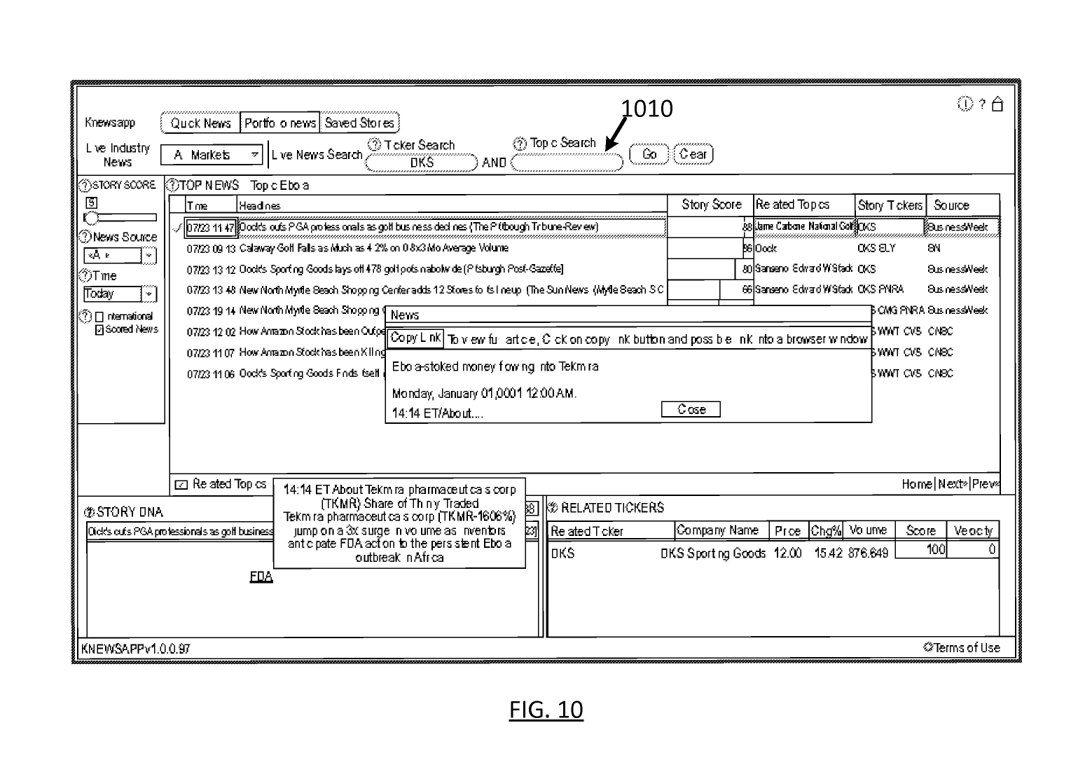

FIG. 10 is an additional screenshot of the user interface and output screen 120 during use of a topic search feature 1010. The topic search feature 1010 enables a user to search for news articles by topic. When the user enters a topic, the system 100 identifies stored news articles in which the system 100 has discovered the topic, and displays the articles' headlines or other article summaries.

In the case of the screenshot shown in FIG. 10, user has used the topic search feature 1010 to input the word “ebola”. In response, the system 100 has retrieved the headlines of ten news articles in which it has discovered coverage of the topic of ebola. The system 100 displays the headlines as part of the list of news stories 704.

Each of the ten news article headlines displayed on the list of news stories 704 is displayed in combination with a representation of additional topics (other than ebola) that the system 100 has discovered in the document. For example, FIG. 10 shows that, at 1006, the system 100 displays a news article headline entitled “Ebola-Stoked Money Flowing Into Tekmira”. At 1008, the system 100 displays an indication that the system 100 has discovered that the topics “FDA” and “Tekmira Pharmaceuticals” have been addressed in this news article.

Additionally, FIG. 10 shows that a user has placed a cursor over the topic represented by the letters “FDA” within the “Story DNA” section of the user interface and display screen 120. As a result of the cursor being placed over “FDA”, the system 100 retrieves a segment 1020 of the news article that corresponds to the highlighted (first) headline shown at 1006. The segment 1020 of the news article is a phrase identified by the system 100, through its text and grammatical analysis of the article, as being be of primary significance to the topic “FDA”.

The aforementioned description has described a system that uses certain operations, methods and technical improvements for identifying relevant news in a financial context. However, there are several analogous other uses for this system which could be easily implemented in view of the disclosure thus far. For example, the system could be used by media or internet companies to identify webpages that are on the cusp of receiving large increases in web visitors. This identification could be performed by adapting the text parsing and analysis described above so that it could be used to analyze user reviews and comments on webpages.

As another example, the system could be used by governments for intelligence or national security purposes. For example, individuals who are on the cusp of becoming national security threats or people of interest could be identified based on the frequency of their communications, the topics that they read about on the internet and in the media, and the topics that are addressed in communications that they read or draft.

The methods, systems, devices, implementations, and embodiments discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Some systems may use Hadoop®, an open-source framework for storing and analyzing big data in a distributed computing environment. Some systems may use cloud computing, which can enable ubiquitous, convenient, on-demand network access to a shared pool of configurable computing resources (e.g., networks, servers, storage, applications and services) that can be rapidly provisioned and released with minimal management effort or service provider interaction. Some grid systems may be implemented as a multi-node Hadoop® cluster, as understood by a person of skill in the art. Apache™ Hadoop® is an open-source software framework for distributed computing.

Specific details are given in the description to provide a thorough understanding of examples of configurations (including implementations). However, configurations may be practiced without these specific details. For example, well-known circuits, processes, algorithms, structures, and techniques have been shown without unnecessary detail in order to avoid obscuring the configurations. This description provides examples of configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several examples of configurations, various modifications, alternative constructions, and equivalents may be used without departing from the spirit of the disclosure. For example, the above elements may be components of a larger system, wherein other rules may take precedence over or otherwise modify the application of the current disclosure. Also, a number of operations may be undertaken before, during, or after the above elements are considered. Accordingly, the above description does not bound the scope of the claims.

The use of “capable of”, “adapted to”, or “configured to” herein is meant as open and inclusive language that does not foreclose devices adapted to or configured to perform additional tasks or operations. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Some systems may use cloud computing, which can enable ubiquitous, convenient, on-demand network access to a shared pool of configurable computing resources (e.g., networks, servers, storage, applications and services) that can be rapidly provisioned and released with minimal management effort or service provider interaction. Some systems may use Hadoop® to read big data once and analyze it several times by persisting it in-memory for the entire session. Some systems may be of other types, designs and configurations.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. A system comprising:
one or more processors;
a non-transitory processor-readable storage medium containing instructions configured that, when executed by the one or more processors, cause the one or more processors to perform operations including:
accessing a first document;
identifying a first topic and a second topic within a news article, wherein both the first topic and the second topic are represented by words in the news article, and wherein the words in the news article are associated with grammatical structures;
quantifying a strength of a relationship between the first topic and second topic within the news article, wherein the strength of the relationship is quantified based on the grammatical structures;
accessing data regarding strength of relationships between the first topic and the second topic in other news articles and a frequency of co-occurrence of the first topic and the second topic within the other news articles;
calculating a relevance score with respect to the news article, wherein the relevance score is calculated at a computing-device and based on:
the strength of the relationship between the first topic and the second topic; and
the data regarding strength of relationships between the first topic and the second topic within the other news articles; and
selecting the news article for display, wherein the news article is selected from amongst multiple other news articles evaluated for display, and wherein the news article is selected based on the relevance score.

2. The system of claim 1, wherein the operations further include:
displaying a title of the news article in conjunction with the relevance score.

3. The system of claim 2, wherein displaying the title of the news article in conjunction with the relevance score facilities identifying news articles that address topics that will receive increased news media attention.

4. The system of claim 2, wherein displaying the title of the news article includes displaying an indication that the news article addresses the first topic and the second topic.

5. The system of claim 1, wherein the title of the news article is displayed such that the title is a selectable link for accessing the news article.

6. The system of claim 1, wherein the operations further include:
identifying an excerpt of the news article, wherein identifying the excerpt includes determining that the excerpt addresses the first topic;
storing metadata that indexes the first topic and the second topic to the news article and indexes the excerpt to the first topic;
detecting a selection input involving the displayed title of the news article; and
in response to detecting the selection, displaying the excerpt.

7. The system of claim 6, wherein the operations further include:
identifying a company referenced in the news article;
quantifying a strength of a relationship between the first topic and the company within the news article;
quantifying a strength of a relationship between the second topic and the company within the news article, wherein the relevance score is further calculated based on:
the strength of the relationship between the first topic and the company within the news article; and
the strength of the relationship between the second topic and the company within the news article.

8. The system of claim 1, wherein the operations further include:
accessing data regarding strength of relationships between the first topic and the company in the other news articles and a frequency of co-occurrence of the first topic and the company within the other news articles, wherein the relevance score is further calculated based on:
the data regarding the strength of the relationships between the first topic and the company within the news article; and
the frequency of co-occurrence of the first topic and the company within the other news articles

9. The system of claim 8, wherein the operations further include:
accessing data regarding strength of relationships between the second topic and the company in the other news articles and a frequency of co-occurrence of the second topic and the company within the other news articles.

10. A computer-implemented method, comprising:
accessing a first document;
identifying a first topic and a second topic within a news article, wherein both the first topic and the second topic are represented by words in the news article, and wherein the words in the news article are associated with grammatical structures;
quantifying a strength of a relationship between the first topic and second topic within the news article, wherein the strength of the relationship is quantified based on the grammatical structures;
accessing data regarding strength of relationships between the first topic and the second topic in other news articles and a frequency of co-occurrence of the first topic and the second topic within the other news articles;
calculating a relevance score with respect to the news article, wherein the relevance score is calculated at a computing-device and based on:
the strength of the relationship between the first topic and the second topic; and
the data regarding strength of relationships between the first topic and the second topic within the other news articles; and
selecting the news article for display, wherein the news article is selected from amongst multiple other news articles evaluated for display, and wherein the news article is selected based on the relevance score.

11. The method of claim 10, further comprising:
displaying a title of the news article in conjunction with the relevance score.

12. The method of claim 11, wherein displaying the title of the news article in conjunction with the relevance score facilities identifying news articles that address topics that will receive increased news media attention.

13. The method of claim 11, wherein displaying the title of the news article includes displaying an indication that the news article addresses the first topic and the second topic.

14. The method of claim 10, wherein the title of the news article is displayed such that the title is a selectable link for accessing the news article.

15. The method of claim 10, further comprising:
identifying an excerpt of the news article, wherein identifying the excerpt includes determining that the excerpt addresses the first topic;
storing metadata that indexes the first topic and the second topic to the news article and indexes the excerpt to the first topic;
detecting a selection input involving the displayed title of the news article; and
in response to detecting the selection, displaying the excerpt.

16. The method of claim 15, further comprising:
identifying a company referenced in the news article;
quantifying a strength of a relationship between the first topic and the company within the news article;
quantifying a strength of a relationship between the second topic and the company within the news article, wherein the relevance score is further calculated based on:
the strength of the relationship between the first topic and the company within the news article; and
the strength of the relationship between the second topic and the company within the news article.

17. The method of claim 10, further comprising:
accessing data regarding strength of relationships between the first topic and the company in the other news articles and a frequency of co-occurrence of the first topic and the company within the other news articles, wherein the relevance score is further calculated based on:
the data regarding the strength of the relationships between the first topic and the company within the news article; and
the frequency of co-occurrence of the first topic and the company within the other news articles.

18. The method of claim 17, further comprising:
accessing data regarding strength of relationships between the second topic and the company in the other news articles and a frequency of co-occurrence of the second topic and the company within the other news articles.

19. A computer-program product comprising a non-transitory machine-readable storage medium having instructions stored therein, the instructions operable to cause a data processing apparatus to perform operations including:
accessing a first document;
identifying a first topic and a second topic within a news article, wherein both the first topic and the second topic are represented by words in the news article, and wherein the words in the news article are associated with grammatical structures;
quantifying a strength of a relationship between the first topic and second topic within the news article, wherein the strength of the relationship is quantified based on the grammatical structures;
accessing data regarding strength of relationships between the first topic and the second topic in other news articles and a frequency of co-occurrence of the first topic and the second topic within the other news articles;
calculating a relevance score with respect to the news article, wherein the relevance score is calculated at a computing-device and based on:
the strength of the relationship between the first topic and the second topic; and
the data regarding strength of relationships between the first topic and the second topic within the other news articles; and
selecting the news article for display, wherein the news article is selected from amongst multiple other news articles evaluated for display, and wherein the news article is selected based on the relevance score.

20. The computer-program product of claim 19, wherein the operations further include:
displaying a title of the news article in conjunction with the relevance score.

21-27. (canceled)
